(19) United States
(12) Patent Application Publication
(10) Pub. No.: US 2025/0030381 A1
(43) Pub. Date: Jan. 23, 2025

(54) SCANNING CONTROL DEVICE

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/616,381

(22) Filed: Mar. 26, 2024

(30) Foreign Application Priority Data
Jul. 18, 2023 (JP) 2023-116765

(51) Int. Cl. H02S 50/00; B60L 53/51; B60R 16/03; H02S 10/40

(52) U.S. Cl. CPC H02S 50/00; B60R 16/03; H02S 10/40; B60L 53/51

(57) ABSTRACT

A scanning control device for controlling, in a solar module, a scanning process for scanning an output voltage of a solar panel to search for a maximum power point includes an acquisition unit for acquiring information on travel of a vehicle, and an instruction unit for instructing an execution frequency of the scanning process by a power generation control unit based on the information on travel of the vehicle, and the instruction unit sets a first frequency, which is a frequency of the scanning process to be executed by the power generation control unit when the vehicle speed included in the information on travel of the vehicle is equal to or less than a first threshold value, to be lower than a second frequency, which is a frequency of the scanning process to be executed by the power generation control unit when the vehicle speed exceeds the first threshold value.

### CROSS-REFERENCE TO RELATED APPLICATION

This application claims priority to Japanese Patent Application No. 2023-116765 filed on Jul. 18, 2023, incorporated herein by reference in its entirety.

### BACKGROUND

### 1. Technical Field

The present disclosure relates to scanning control devices included in solar charging systems mounted on vehicles etc.

### 2. Description of Related Art

Japanese Unexamined Patent Application Publication No. 2020-141545 (JP 2020-141545 A) discloses an in-vehicle solar charging system provided with solar panels. In the solar charging system described in JP 2020-141545 A, each solar control device performs Maximum Power Point Tracking (MPPT) control on a corresponding one of the solar panels. In this MPPT control, in order to accurately find a maximum power point when the output voltage of a solar panel changes due to an environmental change such as a change in solar radiation condition, a scanning process of scanning the output voltage of the solar panel is executed to find an optimum point on a power-voltage (P-V) curve.

### SUMMARY

The maximum power a solar panel can generate changes constantly depending on the environment in which the solar panel is installed, such as solar radiation condition and outside temperature. In particular, in the case where a solar charging system is mounted on a vehicle, the amount of sunlight incident on a solar panel is considered to change according to the traveling condition of the vehicle (e.g., the vehicle is inside a tunnel, or a shadow of a building is on the vehicle).

The power that can be obtained during a scanning process of the solar panel is smaller than the power that can be obtained during normal power generation. Therefore, depending on the solar radiation condition on the solar panel, the power that can be generated by executing a new scanning process increases in some cases and does not change in other cases. Particularly in the latter cases, when the power obtained by executing a new scanning process is almost the same as the power obtained by executing the previous scanning process, the amount of power that is lost (cannot be obtained) by executing the new scanning process is larger than the amount of power that can be obtained by executing the new scanning process, which reduces the overall power generation efficiency of the solar charging system.

The present disclosure was made in view of the above issue, and it is an object of the present disclosure to provide a scanning control device that can suitably control execution of a scanning process to improve the overall power generation efficiency of a solar charging system.

In order to solve the above issue, an aspect of a technique of the present disclosure is a scanning control device that controls a scanning process in a solar module, the solar module including a solar panel mounted on a vehicle and a power generation control unit configured to control power generation of the solar panel, and the scanning process being a process of scanning an output voltage of the solar panel to find a maximum power point and being executed by the power generation control unit.

The scanning control device includes:
an acquisition unit configured to acquire information on travel of the vehicle; and
an instruction unit configured to instruct a frequency of executing the scanning process by the power generation control unit based on the information on the travel of the vehicle.
   The instruction unit is configured to set a first frequency to a value lower than a second frequency, the first frequency being a frequency of executing the scanning process by the power generation control unit when a vehicle speed included in the information on the travel of the vehicle is equal to or less than a first threshold value, and the second frequency being a frequency of executing the scanning process by the power generation control unit when the vehicle speed is higher than the first threshold value.

According to the scanning control device of the present disclosure, the frequency of executing the scanning process of the solar panel is controlled based on the information on the travel of the vehicle. This can reduce loss of power due to the scanning process, and can improve the overall power generation efficiency of the solar charging system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of a solar charging system including a scanning control device according to the present embodiment;

FIG. 2 is a flow chart of the scanning process control of a first example that is performed by the scanning control device; and

FIG. 3 is a flowchart of scanning process control of a second example that is performed by the scanning control device.

### DETAILED DESCRIPTION OF EMBODIMENTS

The scanning control device of the present disclosure reduces the frequency of executing the scanning process of the solar panel in a state in which high-output power generation is stably performed, such as when a vehicle equipped with a solar charging system is stopped (parked). As a result, the amount of generated power that cannot be obtained during the execution of the scanning process is reduced, and the power generation efficiency of the entire solar charging system is improved.

Hereinafter, an embodiment of the present disclosure will be described in detail with reference to the drawings.

### Embodiment

### Configuration

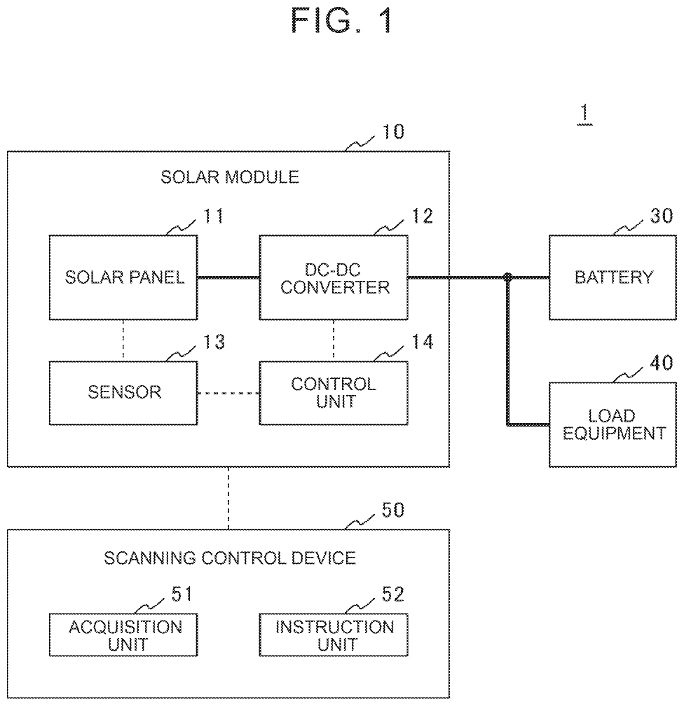

FIG. 1 is a block diagram illustrating a schematic configuration of a solar charging system 1 including a scanning control device 50 according to an embodiment of the present disclosure. The solar charging system 1 illustrated in FIG. 1 includes a solar module 10, a battery 30, a load device 40, and a scanning control device 50. In FIG. 1, a connection line through which power is transmitted is indicated by a thick solid line, and a connection line through which control signals, detection values, and the like other than power are transmitted and received is indicated by a dotted line. In the present embodiment, the solar charging system 1 is mounted on vehicles such as hybrid electric vehicle (HEV), plug-in hybrid electric vehicle (PHEV), and battery electric vehicle (BEV).

The solar module 10 is a power generation device that generates power by being irradiated with sunlight. The solar module 10 can output the generated power to the battery 30, the load device 40, or the like connected to the solar module 10. The solar module 10 includes a solar panel 11, a DCDC converter 12, a sensor 13, and a control unit 14.

In FIG. 1, an example in which the solar charging system 1 includes only one solar module 10 has been described. However, the solar charging system 1 may include two or more solar modules.

The solar panel 11 is a device capable of generating power according to the irradiation amount of sunlight, and is typically an aggregate of solar cells. The solar panel 11 is installed in a roof, a bonnet, a back door, a trunk, a window, or the like of a vehicle. In the case where there is a plurality of solar panels, the solar panels may be arranged side by side in a planar manner, or may be arranged in a three-dimensional manner in a superimposed manner.

DCDC converter 12 is configured to control power generation of the solar panel 11. DCDC converter 12 is a power converter for inputting power generated by the solar panel 11, converting the input power into a predetermined voltage, and outputting the voltage. DCDC converter 12 performs control such as converting and outputting generated power in accordance with control (instruction) from the control unit 14. The power of DCDC converter 12 is supplied to the battery 30 and the load device 40.

The sensor 13 is a configuration for acquiring a power generation state of the solar panel 11. The sensor 13 can acquire physical quantities such as an output voltage, an output current, a temperature, and generated power of the solar panel 11 as a power generation state of the solar panel 11. Various detection elements such as a voltage sensor and a current sensor may be used for the sensor 13. Note that the sensor 13 may be integrally formed with the solar panel 11.

The control unit 14 is a configuration for controlling the operation of DCDC converter 12. The control unit 14 controls (and instructs) DCDC converter 12 based on the power generation status of the solar panel 11 acquired by the sensor 13. The control includes control for outputting a voltage command for generating power to DCDC converter 12, and MPPT control for executing a scanning process for searching for a maximum power point of the solar panel 11. A well-known technique can be used for MPPT control of the present embodiment. The control unit 14 constitutes a power generation control unit that controls power generation of the solar panel 11 together with the above-described DCDC converter 12.

The battery 30 is a secondary battery configured to be chargeable and dischargeable, such as a lithium ion battery or a lead storage battery. The battery 30 is connected to the solar module 10, and is configured to be charged with power generated by the solar panel 11 via DCDC converter 12.

The load device 40 is connected to the battery 30, and is a variety of devices that operate with power supplied from the battery 30.

The scanning control device 50 monitors the traveling state of the vehicles and the power generation state of the solar panel 11 in the solar module 10, and suitably controls the scanning process of MPPT control that is executed by DCDC converter 12. The scanning control device 50 is typically configured as an electronic control unit (Electronic Control Unit, ECU) including a processor, a memory, and an input/output interface, and the processor reads and executes a program stored in the memory to realize the functions of the acquisition unit 51 and the instruction unit 52 described below.

The acquisition unit 51 acquires information on travel of the vehicle. Examples of the information on travel of the vehicle include a speed (vehicle speed), a traveling direction, and a road gradient of the vehicle. Further, the acquisition unit 51 acquires information on power generation of the solar panel 11. The information on the power generation of the solar panel 11 includes information on the current power generation status (voltage, current) of the solar panel 11. In addition, the acquisition unit 51 can acquire information on the temperature of the solar panel 11, information on the past power generation status by the solar panel 11, and information on the environment including at least the position where the solar panel 11 is located and the weather at the position as the information on the power generation of the solar panel 11.

The instruction unit 52 instructs the solar module 10 to execute the scanning process based on the information on the travel of the vehicle acquired by the acquisition unit 51. Further, the instruction unit 52 can instruct the frequency of executing the scanning process by the solar module 10 based also on the information on the power generation of the solar panel 11 acquired by the acquisition unit 51. Details of the execution control of the scanning process by the instruction unit 52 will be described later.

In the above-described configuration example, the solar module 10 and the scanning control device 50 are described as separate configurations, but the solar module 10 and the scanning control device 50 may be integrated. Further, the control function realized by the scanning control device 50 is not limited to the division by the blocks of the acquisition unit 51 and the instruction unit 52 described above, and the division thereof can be arbitrarily set.

### Control

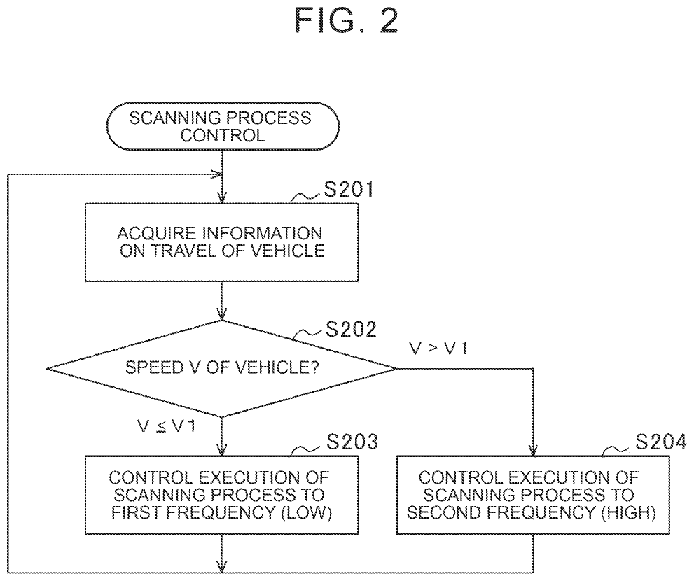

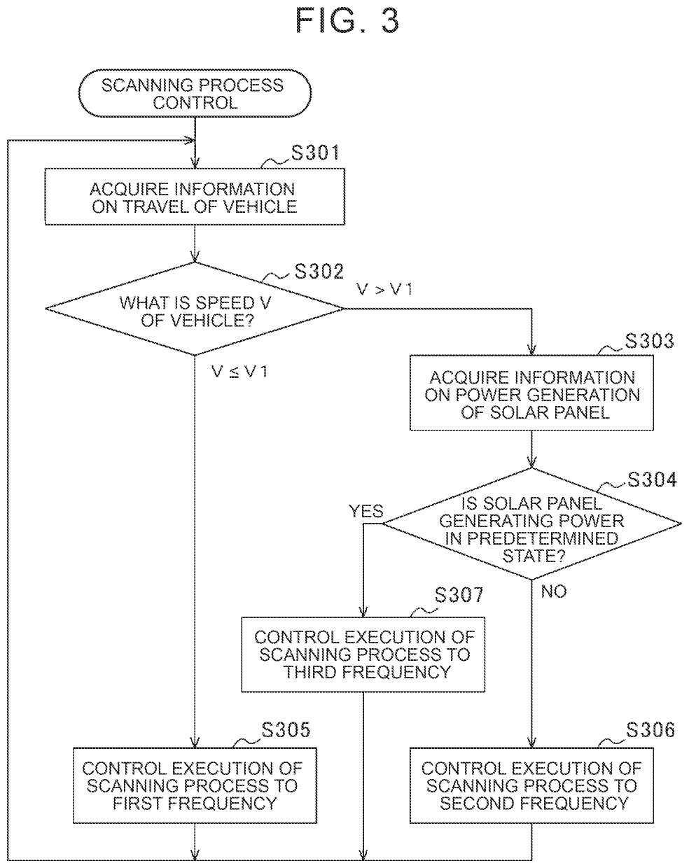

With further reference to FIGS. 2 and 3, the control performed in the solar charging system 1 will be described. FIG. 2 is a flowchart showing a procedure of the scanning process control of the first example executed by the scanning control device 50 according to the present embodiment. FIG. 3 is a flowchart showing a procedure of the scanning process control of the second example executed by the scanning control device 50 according to the present embodiment.

### (1) First Example

The scanning process control of the first example shown in FIG. 2 is started, for example, when the solar charging system 1 is activated, and is repeatedly executed until the solar charging system 1 is stopped.

### S201

The acquisition unit 51 of the scanning control device 50 acquires information on travel of the vehicle on which the solar charging system 1 is mounted. For example, the acquisition unit 51 acquires, as information on travel of the vehicle, information that can grasp whether the vehicle is moving or stopped (whether or not the vehicle is traveling), such as the speed of the vehicle. The speed of the vehicle may be obtained from a speed sensor or the like mounted on the vehicle.

When the acquisition unit 51 acquires information about the traveling of the vehicles, the process proceeds to S202.

### S202

The instruction unit 52 of the scanning control device 50 determines whether the vehicle is in a moving state or a stopped state based on the information on the travel of the vehicle acquired by the acquisition unit 51. Typically, the instruction unit 52 determines whether the speed V of the vehicle, which is information on travel of the vehicle, is larger or smaller than the first threshold value V1. The first threshold value V1 may be 0 km/h, for instance.

When the instruction unit 52 determines that the speed V of the vehicle is equal to or lower than the first threshold value V1 and the vehicle is stopped (S202, V≤V1), the process proceeds to S203. On the other hand, when the instruction unit 52 determines that the speed V of the vehicle exceeds the first threshold value V1 and the vehicle is moving (traveling) (S202, V>V1), the process proceeds to S204.

### S203

The instruction unit 52 of the scanning control device 50 instructs the solar module 10 to execute the scanning process on the solar panel 11 at the first frequency. In this first example, the first frequency is set to be lower than the second frequency described later. By performing this instruction, the number of times the scanning process is executed in a predetermined period is reduced compared to the case where the control is not performed.

When the instruction unit 52 instructs the solar module 10 to execute the scanning process of the solar panel 11 at the first frequency, the process proceeds to S201.

### S204

The instruction unit 52 of the scanning control device 50 instructs the solar module 10 to execute the scanning process of the solar panel 11 at a second frequency. In this first example, the second frequency is set to be higher than the first frequency described above. By performing this instruction, the number of times the scanning process is executed in a predetermined period is increased compared to the case where this instruction is not performed.

When the instruction unit 52 instructs the solar module 10 to execute the scanning process of the solar panel 11 at the second frequency, the process proceeds to S201.

As described above, in the scanning process control of the first example, since it is considered that the power generation state of the solar panel 11 is stable during the period in which the vehicle is stopped (or parked), the frequency of executing the scanning process of the solar panel 11 is reduced to reduce a decrease in overall power generation efficiency of the solar charging system 1.

### (2) Second Example

The scanning process control of the second example shown in FIG. 3 is started, for example, when the solar charging system 1 is activated, and is repeatedly executed until the solar charging system 1 is stopped.

### S301

The acquisition unit 51 of the scanning control device 50 acquires information on travel of the vehicle on which the solar charging system 1 is mounted. For example, the acquisition unit 51 acquires, as information on travel of the vehicle, information that can grasp whether the vehicle is moving or stopped (whether or not the vehicle is traveling), such as the speed of the vehicle. The speed of the vehicle may be obtained from a speed sensor or the like mounted on the vehicle.

When the acquisition unit 51 acquires information about the traveling of the vehicles, the process proceeds to S302.

### S302

The instruction unit 52 of the scanning control device 50 determines whether the vehicle is in a moving state or a stopped state based on the information on the travel of the vehicle acquired by the acquisition unit 51. Typically, the instruction unit 52 determines whether the speed V of the vehicle, which is information on travel of the vehicle, is larger or smaller than the first threshold value V1. The first threshold value V1 may be, for example, 0 km/h.

When the instruction unit 52 determines that the speed V of the vehicle is equal to or lower than the first threshold value V1 and the vehicle is stopped (S302, V≤V1), the process proceeds to S305. On the other hand, when the instruction unit 52 determines that the speed V of the vehicle exceeds the first threshold value V1 and the vehicle is moving (traveling) (S302, V>V1), the process proceeds to S203.

### S303

The acquisition unit 51 of the scanning control device 50 acquires information on power generation of the solar panel 11. The acquisition unit 51 acquires the current power generation status of the solar panel 11 as information on power generation of the solar panel 11. However, in addition to this, for example, the acquisition unit 51 may acquire information on the temperature of the solar panel 11, information on the past power generation status (power generation result) by the solar panel 11, and/or information on the environment including the position where the solar panel 11 is present, the weather at the position, and the like.

The current power generation status (voltage, current) and temperature of the solar panel 11 may be acquired from the sensor 13 or the like. The past power generation status of the solar panel 11 is, as an example, the actual maximum power generation power, the average power generation power, the total power generation amount, and the like (time unit, day unit, and the like) collected so far. A storage unit (not shown) included in the solar module 10 or the scanning control device 50 may store information on the past power generation status. The location where the solar panel 11 is present may be the location of the vehicle (e.g., travel location, parking location, etc.). The information on the position of the vehicles and the weather at the position thereof may be acquired from a navigation device equipped with a GPS function, a predetermined external facility (information center, server, or the like), or the like.

When the acquisition unit 51 acquires information regarding the power generation of the solar panel 11, the process proceeds to S304.

### S304

The instruction unit 52 of the scanning control device 50 determines whether or not the solar panel 11 is able to generate power in a predetermined state. The power generation in the predetermined state means that the solar panel 11 stably generates power with an output close to the target power set in advance as the target value of the power generated by the solar panel 11. More specifically, when a state in which the difference between the target power and the actual generated power of the solar panel 11 is equal to or less than a predetermined threshold value (second threshold value) and the variation value of the generated power of the solar panel 11 is equal to or less than a predetermined threshold value (third threshold value) continues for a predetermined time, the instruction unit 52 determines that the solar panel 11 is generating power in the predetermined state.

When the instruction unit 52 determines that the solar panel 11 is able to generate power in a predetermined condition (S304, Yes), the process proceeds to S307. On the other hand, when the instruction unit 52 determines that the solar panel 11 is not able to generate power in a predetermined condition (S304, No), the process proceeds to S306.

### S305

The instruction unit 52 of the scanning control device 50 instructs the solar module 10 to execute the scanning process of the solar panel 11 at the first frequency. In this second example, the first frequency is set to be lower than the second frequency described later. By performing this instruction, the number of times the scanning process is executed in a predetermined period is reduced compared to the case where the control is not performed.

When the instruction unit 52 instructs the solar module 10 to execute the scanning process of the solar panel 11 at the first frequency, the process proceeds to S301.

### S306

The instruction unit 52 of the scanning control device 50 instructs the solar module 10 to execute the scanning process of the solar panel 11 at a second frequency. In this second example, the second frequency is set to be higher than the first frequency described above. By performing this control, the number of times the scanning process is executed in a predetermined period is increased compared to the case where this control is not performed.

When the instruction unit 52 instructs the solar module 10 to execute the scanning process of the solar panel 11 at the second frequency, the process proceeds to S301.

### S307

The instruction unit 52 of the scanning control device 50 instructs the solar module 10 to execute the scanning process of the solar panel 11 at a third frequency. In this second example, the third frequency is set to be lower than the second frequency described above. The third frequency may be the same as the first frequency, or may be different from the first frequency. By performing this control, the number of times the scanning process is executed in a predetermined period is reduced compared to the case where the control for setting the second frequency is performed.

When the instruction unit 52 instructs the solar module 10 to execute the scanning process of the solar panel 11 at the third frequency, the process proceeds to S301.

As described above, in the scanning process control of the second example, as compared with the scanning process control of the first example, if the solar panel 11 is in a state in which stable power close to the target power can be output even when the vehicle is traveling, the frequency of executing the scanning process of the solar panel 11 is reduced to reduce a decrease in overall power generation efficiency of the solar charging system 1.

Note that the target power of the solar panel 11 used in the scanning process control of the first example and the second example described above may be variably set based on the information on the power generation of the solar panel 11 acquired by the acquisition unit 51. As a method of setting the target power, a method of setting the maximum power derived from the temperature of the solar panel 11 as the target power by using a map, an arithmetic expression, or the like showing a relationship between the temperature of the solar panel 11 and the maximum power that can be output is exemplified. In addition, using the data related to the past power generation status of the solar panel 11, the power derived from the past power generation status that is approximate to the current situation may be set as the target power. Further, for example, using weather information of a parking location of a vehicle received from an external information center, power derived by coordinating the environment information, information of the temperature of the solar panel 11, and information of the past power generation status may be set as the target power.

Further, as another case in which the instruction unit 52 instructs the solar module 10 to execute the scanning process of the solar panel 11 at the first frequency, there are various conditions such as a case in which the temperature of the solar panel 11 is higher than a predetermined value, a case in which the past power generation status in the traveling area of the vehicle is poor, and a case in which the weather of the parking place will get worse in the future.

### Operations and Effects

As described above, according to the scanning control device of the embodiment of the present disclosure, when the vehicle is in a state such as a stop in which the vehicle is not moving based on the information on the traveling of the vehicle in which the solar charging system is mounted, the frequency of executing the scanning process of the solar panel is relatively low compared with the state in which the vehicle is moving.

By this control, it is possible to reduce the number of times the scanning process is executed while the vehicle is stopped (parking) in which it is estimated that the power generation status of the solar panel is stably continued, and it is possible to suppress the loss of the opportunity to acquire the power generation amount by executing the scanning process under a stable situation in which it is not expected to obtain a new useful result. Therefore, according to the scanning control device of the present embodiment, it is possible to improve the power generation efficiency of the entire solar charging system (improvement of controllability and improvement of power generation amount).

Although an embodiment of the present disclosure has been described above, the present disclosure can be regarded as a scanning control device, a solar charging system including a scanning control device, a method executed by the scanning control device, a program for executing the method, a computer-readable non-transitory recording medium storing the program, a vehicle equipped with a solar charging system including a scanning control device, and the like.

The scanning control device of the present disclosure can be used in a solar charging system or the like mounted on a vehicle.

What is claimed is:

1. A scanning control device that controls a scanning process in a solar module, the solar module including a solar panel mounted on a vehicle and a power generation control unit configured to control power generation of the solar panel, and the scanning process being a process of scanning an output voltage of the solar panel to find a maximum power point and being executed by the power generation control unit, the scanning control device comprising:
an acquisition unit configured to acquire information on travel of the vehicle; and
an instruction unit configured to instruct a frequency of executing the scanning process by the power generation control unit based on the information on the travel of the vehicle, wherein the instruction unit is configured to set a first frequency to a value lower than a second frequency, the first frequency being a frequency of executing the scanning process by the power generation control unit when a vehicle speed included in the information on the travel of the vehicle is equal to or less than a first threshold value, and the second frequency being a frequency of executing the scanning process by the power generation control unit when the vehicle speed is higher than the first threshold value.

2. The scanning control device according to claim 1, wherein:
the acquisition unit is configured to further acquire information on the power generation of the solar panel; and
the instruction unit is configured to control the frequency of executing the scanning process by the power generation control unit to a third frequency when a state in which a difference between target power set as a target value of power that is generated by the solar panel and power generated by the solar panel is equal to or less than a second threshold value and a fluctuation value of the power generated by the solar panel is equal to or less than a third threshold value has continued for a predetermined period, the third frequency being lower than the second frequency.

3. The scanning control device according to claim 2, wherein the information on the power generation includes at least one of the following information: information on a temperature of the solar panel, information on a past power generation status of the solar panel, and information on an environment including a location where the solar panel is present and weather at the location.
